(19) United States
(12) Patent Application Publication
(10) Pub. No.: US 2026/0073932 A1
(43) Pub. Date: Mar. 12, 2026

(54) SYSTEM AND METHOD FOR DATA AUGMENTATION AND AUDIO PROCESSING USING TINY DNN MODELS

(71) Applicant: Samsung Electronics Co., Ltd., Gyeonggi-do (KR)

(72) Inventors: Behnam BABAGHOLAMI MOHAMADABADI, Escondido, CA (US); Mostafa EL-KHAMY, San Diego, CA (US)

(21) Appl. No.: 19/318,006

(22) Filed: Sep. 3, 2025

Related U.S. Application Data
(60) Provisional application No. 63/691,799, filed on Sep. 6, 2024.

(51) Int. Cl. G10L 21/10; G10L 21/0216

(52) U.S. Cl. CPC G10L 21/10; G10L 21/0216; G10L 2021/02163

(57) ABSTRACT

A system and a method are disclosed for data augmentation. A method includes obtaining a plurality of noisy spectrograms; extracting noise components from the plurality of noisy spectrograms; individually generating a mixup coefficient for each of the extracted noise components; applying the mixup coefficients to the extracted noise components; merging the extracted noise components; and combining the merged noise components with a clean spectrogram to provide an augmented sample.

### CROSS-REFERENCE TO RELATED APPLICATION

This application claims the priority benefit under 35 U.S.C. § 119(e) of U.S. Provisional Application No. 63/691,799, filed on Sep. 6, 2024, the disclosure of which is incorporated by reference in its entirety as if fully set forth herein.

### TECHNICAL FIELD

The disclosure generally relates to audio signal denoising and enhancement. More particularly, the subject matter disclosed herein relates to improvements to a training pipeline with a proper loss function and data augmentation to increase performance of tiny deep neural networks (DNN) models, e.g., tiny speech enhancement (SE) models.

### SUMMARY

A goal of an SE task is to process a noisy audio signal, e.g., a speech input signal, and provide an estimate of clean speech. For example, an SE task may be to improve the quality of detected speech by using various algorithms.

While modern deep learning-based models have significantly outperformed traditional methods in the area of SE, they often necessitate a relatively large number of parameters and extensive computational power, making them impractical to be deployed on edge devices in real-world applications. That is, SE algorithms based on DNNs often encounter challenges of limited hardware resources or strict latency requirements when deployed in real world scenarios.

To address these types of problems, tiny DNN models have been developed, which are intended to provide sufficient accuracy for certain tasks while having a minimal size and computational footprint, making them better suited for deployment on resource-constrained devices like embedded systems or Internet of things (IoT) devices. For example, such a library is “tiny-dnn”, a header-only, dependency-free C++ library designed specifically for tiny DNNs.

To provide tiny DNN models, the focus has been on architecture optimization, e.g., reduced layer depth by using fewer layers in the network, smaller filter sizes in convolutional layers (for image tasks), or quantization by reducing the precision of weights and activations to smaller data types (e.g., 8-bit), and different training techniques, such as knowledge distillation, i.e., transferring knowledge from a larger pre-trained model to a smaller one, pruning by removing redundant connections in the network, and regularization to prevent overfitting. The performance of such systems can be measured in terms of intelligibility and quality of the estimated clean signal (e.g., using objective metrics such as spectro-temporal objective intelligibility (STOI) or perceptual evaluation of speech quality (PESQ)).

However, despite the reduction in computational overhead achieved by these types of approaches, they still suffer from limited performance, i.e., deploying tiny DNN models satisfying hardware constraints often still provides unsatisfactory results.

Accordingly, an aspect of the present disclosure is to provide improve intelligibility and/or overall perceptual quality of degraded speech signals using audio signal processing techniques.

Another aspect of the disclosure is to provide a novel training pipeline with a proper loss function and data augmentation to increase performance of a tiny SE model.

Another aspect of the disclosure is to provide a training methodology that incorporates a novel data augmentation and combines it with a loss function to train a tiny DNN for SE.

In accordance with an aspect of the disclosure, a data augmentation technique is provided, which extends mixup augmentation to improve SE performance.

More specifically, in accordance with an aspect of the disclosure, mixup augmentation may be extended to allow for the combining of an arbitrary number of samples, rather than just two samples. Additionally, mixup augmentation may be extended to combine noise components of noisy samples, rather than the whole noisy spectrograms. Further, mixup augmentation may be extended by treating each frequency independent of other frequencies by generating mixup coefficients for each spectrogram frequency band, rather than a single coefficient for the whole spectrogram.

In accordance with another aspect of the disclosure, a combination of various time-domain and frequency-domain objective functions may be utilized to further improve performance of tiny DNN models.

In an embodiment, a method for data augmentation comprises obtaining a plurality of noisy spectrograms; extracting noise components from the plurality of noisy spectrograms; individually generating a mixup coefficient for each of the extracted noise components; applying the mixup coefficients to the extracted noise components; merging the extracted noise components; and combining the merged noise components with a clean spectrogram to provide an augmented sample.

In an embodiment, a system for performing data augmentation comprises a processor; and a memory configured to store instructions, which when executed, control the processor to obtain a plurality of noisy spectrograms, extract noise components from the plurality of noisy spectrograms, individually generate a mixup coefficient for each of the extracted noise components, apply the mixup coefficients to the extracted noise components, merge the extracted noise components, and combine the merged noise components with a clean spectrogram to provide an augmented sample.

In an embodiment, an electronic device for performing data augmentation comprises a microphone; and a processor configured to receive an audio signal via the microphone, obtain a plurality of noisy spectrograms from the audio signal, extract noise components from the plurality of noisy spectrograms, individually generate a mixup coefficient for each of the extracted noise components, apply the mixup coefficients to the extracted noise components, merge the extracted noise components, and combine the merged noise components with a clean spectrogram to provide an augmented sample.

### BRIEF DESCRIPTION OF THE DRAWING

In the following section, the aspects of the subject matter disclosed herein will be described with reference to exemplary embodiments illustrated in the figures, in which:

FIG. 1 illustrates an example of a data augmentation method, according to an embodiment;

FIG. 2 is a flowchart illustrating a data augmentation method, according to an embodiment; and

FIG. 3 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As described above, while modern deep learning-based models have significantly outperformed traditional methods in the area of SE, they often necessitate a lot of parameters and extensive computational power, making them impractical to be deployed on edge devices in real-world applications. While some recent works have focused on exploring lightweight SE approaches that achieve somehow satisfying performance while reducing computational requirements, despite the reduction in computational overhead achieved by these types of approaches, they still suffer from limited performance.

In the present disclosure, a training methodology is provided, which designs a proper loss function accompanied with a novel data augmentation technique to boost performance of a tiny DNN-based SE model.

Recently, various tiny DNNs have been proposed for SE tasks on devices.

To further enhance their performance, there have been some efforts in exploring data augmentation and regularization strategies. For augmenting an audio dataset, there are generally two approaches: 1) time-domain waveforms, and 2) time-frequency domain features, such as spectrogram, mel-spectrogram, and mel-frequency cepstral coefficient. Since the time-frequency domain features are two dimensional (2D) and can be projected as a 2D image, data augmentation strategies, particularly of mixed sample data augmentation (MSDA) type in a computer vision domain, have been applied to the time-frequency domain features.

Mixup augmentation blends two images of audio features and labels by varying a random parameter. Its performance has been shown to be effective in image classification tasks, however, due to the way it mixes magnitudes of spectrograms from different source components together it is often difficult to disentangle them in the audio domain. Thus, the performance from a mixup approach has been limited.

In accordance with an embodiment of the disclosure, an audio data augmentation strategy is provided, which may be referred to as frequency band-wise multiple noise mixup (FMN-Mixup), for training with time-frequency domain features.

FMN-Mixup modifies general mixup augmentation 1) by combining only noise components of noisy samples, rather than the whole noisy spectrograms, 2) by generating mixup coefficients for each spectrogram frequency band, rather than a single coefficient for the whole spectrogram, and 3) by combining multiple samples, rather than only two samples.

Herein, x∈R^{N} denote an N-dimensional time domain speech signal corrupted by noise n, and a goal is to extract x from y=x+n. Denoising may be applied in the time-frequency domain, whereby y is transformed into Y using a short-time Fourier transform (STFT).

For a distorted speech waveform y∈R^{N}, an STFT operation may convert the waveform into a complex spectrogram Yₒ∈R^{T×F×2}, where T and F denote the time and frequency dimensions, respectively. Thereafter, a compressed spectrogram Y may be obtained by a power-law compression as shown in Equation (1).

$$Y = {\vert {Y}_{o} \vert}^{c} {e}^{j {Y}_{p}} = {Y}_{m} {e}^{j {Y}_{p}} = {Y}_{r} + {jY}_{i} \qquad ( 1 )$$

In Equation (1), Yₘ, Yₚ, Yᵣ, and Yᵢ denote the magnitude, phase, real, and imaginary components of the compressed spectrogram, respectively, and c is a compression exponent that may be set to c=0.3.

More specifically, given M noisy spectrograms Yⁿ=Xⁿ+Nⁿ, n=1, . . . , M, where Xⁿ and Nⁿ are their corresponding clean and noise spectrograms, respectively, and Yⁿ, Xⁿ, Nⁿ∈R^{F×T×2}, a new augmented sample may be defined as shown in Equation (2).

$${[ \overline{Y} ]}_{f} = {[ X ]}_{f} + {λ}_{f} ⊙ \sum {[ {N}^{n} ]}_{f} , \qquad ( 2 )$$

$$f = 1 , … , F ,$$

$$λ = [ {λ}_{f}^{1} , {λ}_{f}^{2} , … , {λ}_{F}^{M} ] ∼ D i r i c h l e t ( α )$$

In Equation (2), X denotes a randomly chosen clean speech from {Xⁿ}ₙ₌₁^{M}, λ is a F-dimensional random simplex λ_{f}ⁱ≥0, Σλ_{f}ⁱ=1 sampled from a Dirichlet distribution with parameter α, [X]_{f} denotes the frequency band f of the spectrogram X, and ⊙ denotes an element-wise multiplication operator.

The hyper-parameter α∈R^{F} in Equation (2) may be used to specify the extent of mixing. In other words, the control parameter α in a Dirichlet distribution commands the strength of interpolation between noise samples, i.e., a higher α generating relatively stronger interpolated noise samples.

The augmented samples, which arise from utilizing interpolations in the noise space, may generate additional and provide more intricate noisy training samples, which may help a denoiser to be more robust toward unseen noisy environments.

According to an embodiment, a loss function may be utilized, i.e., a magnitude loss L_{Mag} and complex loss L_{RI} in the TF-domain, as shown in Equations (3) and (4), respectively.

$${L}_{Mag} = {E}_{{X}_{m} , {\hat{X}}_{m}} [ {‖ {X}_{m} - {\hat{X}}_{m} ‖}^{2} ] \qquad ( 3 )$$

$${L}_{RI} = {E}_{{X}_{r} , {\hat{X}}_{r}} [ {‖ {X}_{r} - {X}_{r} ‖}^{2} ] + {E}_{{X}_{i} , {\hat{X}}_{i}} [ {‖ {X}_{i} - {\hat{X}}_{i} ‖}^{2} ] \qquad ( 4 )$$

In Equation (3), E denotes an expectation operator, e.g., an averaging operator (averaged over all training data), \hat{x}ₘ is magnitude of an enhanced waveform, xₘ is magnitude of a clean target waveform, Xₘ magnitude of a clean target spectrogram, and \hat{X}ₘ is magnitude of an enhanced target spectrogram.

In Equation 4), \hat{x}ᵣ is a real value of an enhanced waveform, xᵣ is a real value of a clean target waveform, Xᵣ a real value of a clean target spectrogram, and \hat{X}ᵣ is a real value of an enhanced target spectrogram.

A differentiable PESQ algorithm, as shown in Equation (5), which is an objective metric for speech quality evaluation, is also used as a loss function for a model. PESQ generally refers to methods of assessing how humans perceive the quality of spoken audio, often in the context of telecommunications or speech technology. These methods can be either subjective, involving human listeners, or objective, using algorithms that mimic human perception. For example, PESQ may provide a numerical score based on how a degraded signal compares to a reference signal.

$${L}_{P E S Q} = {E}_{x , \hat{x}} [ PESQ ( x , \hat{x} ) ] \qquad ( 5 )$$

In Equation (5), \hat{x} is an enhanced waveform, and x is a clean target waveform.

When the PESQ metric is dominant in a loss function, it may lead to a poor listening quality score. To diminish negative effects of a PESQ loss, a scale invariant signal to distortion ratio (SI-SDR) loss, as shown in Equation (6), may be utilized.

$${L}_{SI - SDR} = {𝔼}_{x , \hat{x}} [ 10 {log}_{10} ( \frac{{‖ \frac{{x}^{T} x}{{‖ x ‖}^{2}} x ‖}^{2}}{{‖ \frac{{x}^{T}}{{‖ x ‖}^{2}} x - \hat{x} ‖}^{2}} ) ] \qquad ( 6 )$$

Moreover, an additional penalization in the resultant waveform, i.e., a time loss, L_{Time}, as shown in Equation (7), may be used to improve the restored speech quality.

$${L}_{Time} = {E}_{x , \hat{x}} [ {‖ x - \hat{x} ‖}_{1} ] \qquad ( 7 )$$

Based on the foregoing, a final loss function may be formulated as shown in Equation (8).

$$L = {γ}_{0} {L}_{Mag} + {γ}_{1} {L}_{RI} + {γ}_{2} {L}_{Time} + {γ}_{3} {L}_{PESQ} + {γ}_{4} {L}_{SI - SDR} \qquad ( 8 )$$

In Equation (8), γ₀, γ₁, γ₂, γ₃, and γ₄ are weights of the corresponding losses and may be chosen to reflect equal importance. That is, the weights may be set to ensure that each loss term contributes proportionally to the total loss function.

As described above with reference to Equations (1) to (8), according to an embodiment, a novel data augmentation may be provided with a proper loss function to increase the performance of a tiny SE model. Specifically, a loss function may be provided by incorporating a differentiable PESQ loss combined with SI-SDR loss to the standard SE loss functions.

Although the above-described embodiment is described using PESQ as an objective metric, the present disclosure is not limited thereto. For example, another metric such as STOI may be utilized.

STOI generally refers to algorithms that predict how well a listener can understand degraded speech by analyzing the patterns of acoustic energy across time and frequency. These methods may be designed to mimic human auditory processing, which relies on the ability to perceive and integrate these modulations.

Further, a data augmentation method according to an embodiment, may be used to expand the concept of mixup augmentation by permitting a combination of an arbitrary number of samples instead of being limited to two, by merging only noise components of noisy samples rather than the entirety of the noisy spectrograms, and by addressing each frequency independently by generating mixup coefficients for each frequency band of the spectrogram, rather than applying a single coefficient to the entire spectrogram.

By training tiny DNN models, e.g., SuperTiny-CMGAN or TinyGRU models, with a loss as shown in Equation (8), the present disclosure may provide improvement, i.e., higher values, in a various objective metrics used to evaluate the quality and intelligibility of speech, particularly in the context of SE, e.g., PESQ, STOI, composite measure for signal distortion (CSIG), composite measure for overall speech quality (COVL), segmental signal-to-noise ratio (SSNR), etc., compared to applying a standard loss function, e.g., CMGAN loss. Further, combining the FMN-Mixup and the above-described loss function further improves the performance metrics of these tiny DNN models.

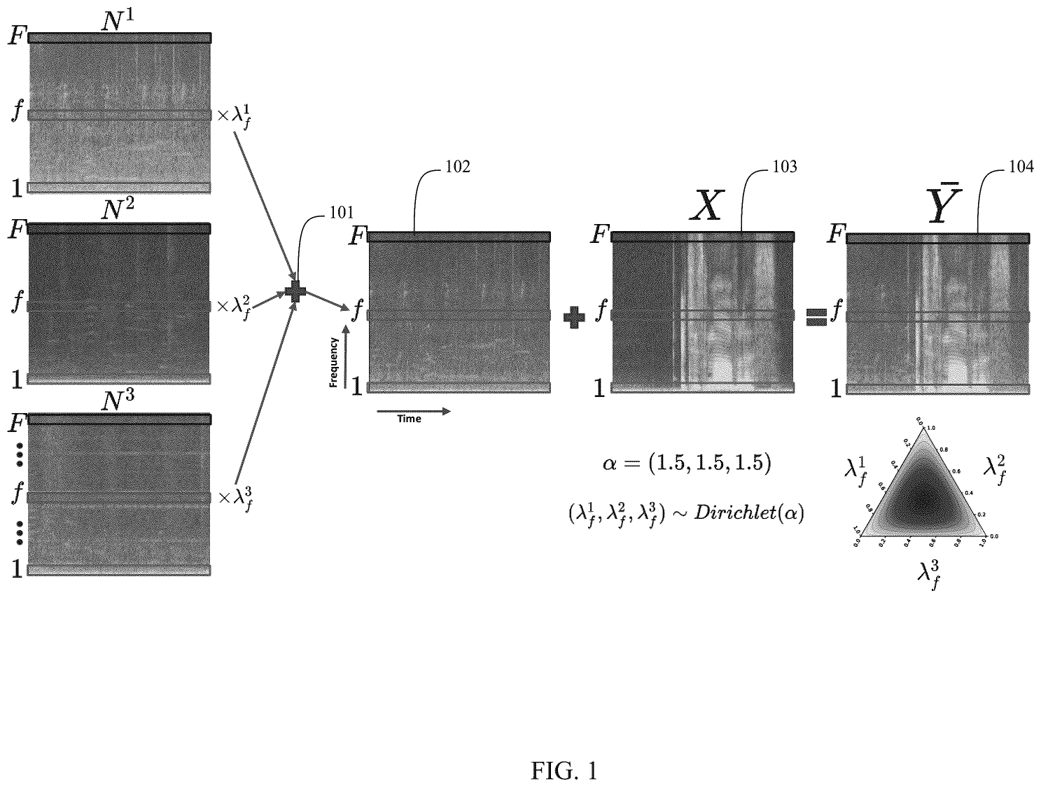

FIG. 1 illustrates an example of a data augmentation method, according to an embodiment. For example, FIG. 1 illustrates an example of determining an augmented sample as defined in Equation (2).

Referring to FIG. 1, the data augmentation method combines three noise components N¹, N², and N³ from three noisy samples Y¹, Y², and Y³, respectively. As described above, a data augmentation method according to an embodiment of the disclosure allows for an arbitrary number of samples instead of being limited to two. Accordingly, although the example in FIG. 1 illustrates the three samples, the present disclosure is not limited thereto, and the data augmentation method may be utilized for two samples or more than three samples.

Additionally, at 101, the data augmentation method merges only the noise components N¹, N², and N³ of the noisy samples Y¹, Y², and Y³, rather than the entirety of the noisy spectrograms.

Further, the data augmentation method may address each frequency independently by generating mixup coefficients for each frequency band f of the spectrogram, i.e., λ_{f}¹, λ_{f}², and λ_{f}³, rather than applying a single coefficient λ to the entire spectrogram. For example, assuming that there are F frequency bands for each noisy spectrogram, for each frequency band f=1, . . . , F, λ_{f}¹, λ_{f}², and λ_{f}³ are generated and the noises are mixed in each frequency band in Equation (2).

Thereafter, the merged noise components 102 may be combined with clean speech X 103 to provide an augmented sample Y̅ 104.

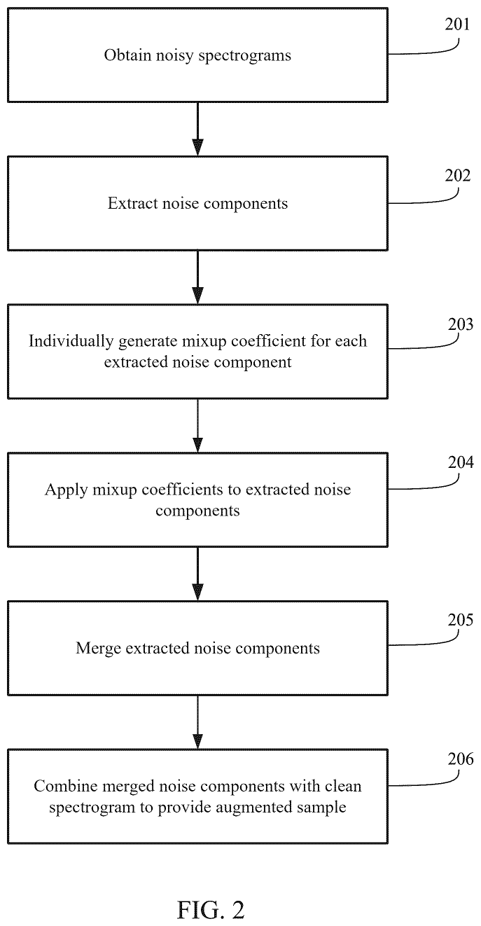

FIG. 2 is a flowchart illustrating a data augmentation method, according to an embodiment of the disclosure.

Referring to FIG. 2, in step 201, an electronic device, e.g., an edge device utilizing a DNN architecture, obtains a plurality of noisy spectrograms. For example, the edge device, such as a smartphone, hearing aid, or smart speaker, using the DNN architecture for SE may obtain a plurality of noisy spectrograms through a process including signal capture, framing (and possibly windowing), and Fourier transformation. The plurality of noisy spectrograms may be a continuous series of spectrograms generated over time from a single, ongoing audio stream.

During signal capture, the edge device may use a microphone to capture sound, e.g., a continuous audio stream, from the environment. This incoming sound may include a mix of desired speech signal and any additive background noise, such as a barking dog, typing keyboard, etc.

During framing and windowing, for spectral analysis, the continuous audio stream may be divided into a series of short, overlapping time segments, or frames. In framing, the audio stream is split into frames, e.g., ranging from 16 to 32 milliseconds. In windowing, a windowing function, such as a Hann or Hamming window, may be applied to each frame to taper the signal at the edges of the frame in order to reduce spectral leakage.

During STFT, after framing and windowing are completed, a discrete Fourier transform (DFT) may be computed for each frame. For example, this step may convert each time-domain frame into the frequency domain, revealing a signal's frequency content at a specific moment in time. The result may be a series of complex numbers representing magnitude and phase of each frequency component.

A final noisy spectrogram may be constructed by stacking the frequency-domain representations over time. Basically, a spectrogram is a visual representation of the spectrum of frequencies in a sound or other signal as they vary with time, where generally the x-axis represents time and the y-axis represents frequency.

The edge device may utilize the noisy spectrograms as its input, and may be trained to clean these spectrograms, effectively learning the mapping from a noisy magnitude spectrum to a clean one.

As described above, a data augmentation method according to an embodiment of the disclosure allows for an arbitrary number of samples instead of being limited to two. Accordingly, the data augmentation method may be utilized for two samples or more than three samples.

In step 202, the electronic device extracts noise components from the plurality of noisy spectrograms.

In step 203, the electronic device individually generates a mixup coefficient for each of the extracted noise components. That is, the data augmentation method may address each frequency independently by generating mixup coefficients for each frequency band of the spectrogram, i.e., λ_{f}¹, λ_{f}², and λ_{f}³, rather than applying a single coefficient λ to the entire spectrogram.

In step 204, the electronic device applies the mixup coefficients to the extracted noise components.

In step 205, the electronic device merges the extracted noise components. As described above, the data augmentation method merges only the extracted noise components of noisy samples, rather than the entirety of the noisy spectrograms.

In step 206, the electronic device combines the merged noise components with a clean spectrogram to provide an augmented sample.

Thereafter, a model may be trained using the augmented sample and a loss function. For example, the model may be trained by feeding the augmented, noisy audio samples alongside their clean speech counterparts. During training, a loss function, such as mean squared error (MSE) or signal-to-distortion ratio (SDR), may be used to quantify the difference between the model's enhanced output and the clean target. The model may then adjust its parameters to minimize this loss, iteratively learning to produce cleaner speech from noisy inputs.

More specifically, by feeding a noisy spectrogram (or its magnitude component, depending on a model's design) into a trained speech enhancement model, the model, which has learned to map noisy spectrograms to their clean counterparts, may then output an estimated clean spectrogram. If the model only processes or outputs the magnitude spectrogram, the phase information from the original noisy spectrogram may be combined with the enhanced magnitude spectrogram.

Thereafter, an inverse STFT (ISTFT) may be performed on the reconstructed clean spectrogram (magnitude and phase) to convert it back into a time-domain audio signal. This resulting time-domain signal is enhanced speech, with a reduced level of noise compared to the original noisy input of the captured audio stream. The enhanced speech may then be output by the edge device, e.g., as audio signal through a speaker or as displayed text after speech recognition is performed on the enhanced speech.

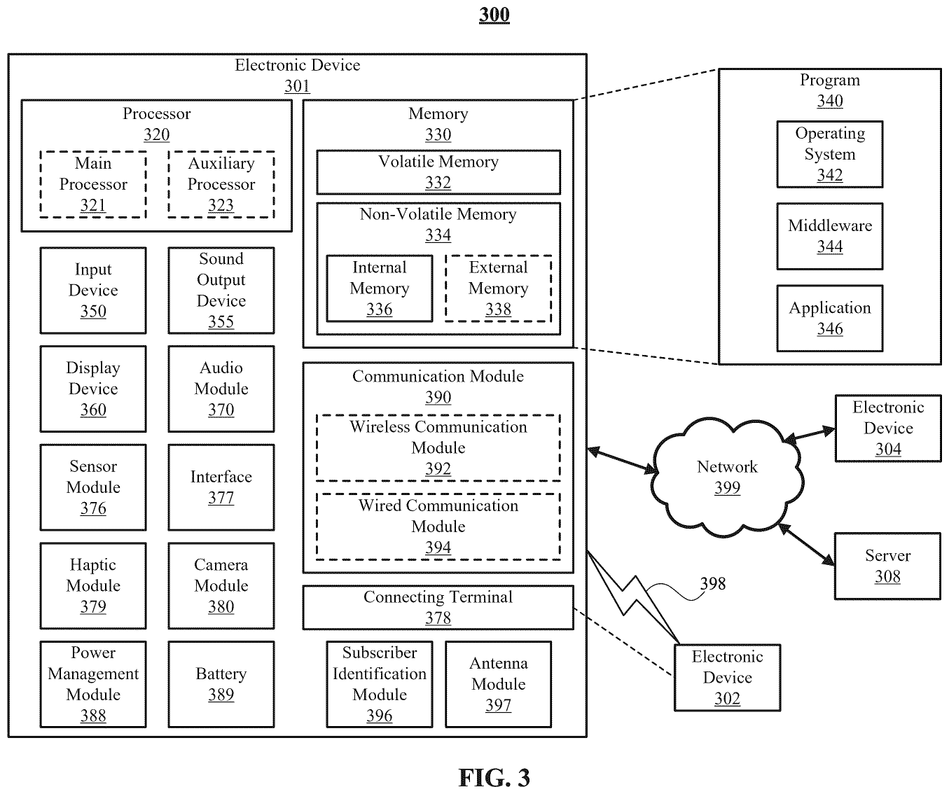

FIG. 3 is a block diagram of an electronic device in a network environment 300, according to an embodiment. For example, the electronic device may be an edge device utilizing a DNN architecture.

Referring to FIG. 3, an electronic device 301 in a network environment 300 may communicate with an electronic device 302 via a first network 398 (e.g., a short-range wireless communication network), or an electronic device 304 or a server 308 via a second network 399 (e.g., a long-range wireless communication network). The electronic device 301 may communicate with the electronic device 304 via the server 308. The electronic device 301 may include a processor 320, a memory 330, an input device 350, a sound output device 355, a display device 360, an audio module 370, a sensor module 376, an interface 377, a haptic module 379, a camera module 380, a power management module 388, a battery 389, a communication module 390, a subscriber identification module (SIM) card 396, or an antenna module 397. In one embodiment, at least one (e.g., the display device 360 or the camera module 380) of the components may be omitted from the electronic device 301, or one or more other components may be added to the electronic device 301. Some of the components may be implemented as a single integrated circuit (IC). For example, the sensor module 376 (e.g., a fingerprint sensor, an iris sensor, or an illuminance sensor) may be embedded in the display device 360 (e.g., a display).

The processor 320 may execute software (e.g., a program 340) to control at least one other component (e.g., a hardware or a software component) of the electronic device 301 coupled with the processor 320 and may perform various data processing or computations.

As at least part of the data processing or computations, the processor 320 may load a command or data received from another component (e.g., the sensor module 376 or the communication module 390) in volatile memory 332, process the command or the data stored in the volatile memory 332, and store resulting data in non-volatile memory 334. The processor 320 may include a main processor 321 (e.g., a central processing unit (CPU) or an application processor (AP)), and an auxiliary processor 323 (e.g., a graphics processing unit (GPU), an image signal processor (ISP), a sensor hub processor, or a communication processor (CP)) that is operable independently from, or in conjunction with, the main processor 321. Additionally or alternatively, the auxiliary processor 323 may be adapted to consume less power than the main processor 321, or execute a particular function. The auxiliary processor 323 may be implemented as being separate from, or a part of, the main processor 321.

The auxiliary processor 323 may control at least some of the functions or states related to at least one component (e.g., the display device 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). The auxiliary processor 323 (e.g., an image signal processor or a communication processor) may be implemented as part of another component (e.g., the camera module 380 or the communication module 390) functionally related to the auxiliary processor 323.

The memory 330 may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 or the non-volatile memory 334. Non-volatile memory 334 may include internal memory 336 and/or external memory 338.

The program 340 may be stored in the memory 330 as software, and may include, for example, an operating system (OS) 342, middleware 344, or an application 346. For example, the program 340 may include various methods disclosed herein, e.g., the method illustrated in FIG. 2.

The input device 350 may receive a command or data to be used by another component (e.g., the processor 320) of the electronic device 301, from the outside (e.g., a user) of the electronic device 301. The input device 350 may include, for example, a microphone, e.g., for capturing an audio signal for obtaining a plurality of noisy spectrograms, a mouse, or a keyboard.

The sound output device 355 may output sound signals to the outside of the electronic device 301, e.g., outputting enhanced speech as an audio signal. The sound output device 355 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 360 may visually provide information to the outside (e.g., a user) of the electronic device 301, e.g., outputting enhanced speech as displayed text after speech recognition is performed on the enhanced speech. The display device 360 may include, for example, a display, a hologram device, or a projector and control circuitry to control a corresponding one of the display, hologram device, and projector. The display device 360 may include touch circuitry adapted to detect a touch, or sensor circuitry (e.g., a pressure sensor) adapted to measure the intensity of force incurred by the touch.

The audio module 370 may convert a sound into an electrical signal and vice versa. The audio module 370 may obtain the sound via the input device 350 or output the sound via the sound output device 355 or a headphone of an external electronic device 302 directly (e.g., wired) or wirelessly coupled with the electronic device 301.

The sensor module 376 may detect an operational state (e.g., power or temperature) of the electronic device 301 or an environmental state (e.g., a state of a user) external to the electronic device 301, and then generate an electrical signal or data value corresponding to the detected state. The sensor module 376 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 377 may support one or more specified protocols to be used for the electronic device 301 to be coupled with the external electronic device 302 directly (e.g., wired) or wirelessly. The interface 377 may include, for example, a high-definition multimedia interface (HDMI), a universal serial bus (USB) interface, a secure digital (SD) card interface, or an audio interface.

A connecting terminal 378 may include a connector via which the electronic device 301 may be physically connected with the external electronic device 302. The connecting terminal 378 may include, for example, an HDMI connector, a USB connector, an SD card connector, or an audio connector (e.g., a headphone connector).

The haptic module 379 may convert an electrical signal into a mechanical stimulus (e.g., a vibration or a movement) or an electrical stimulus which may be recognized by a user via tactile sensation or kinesthetic sensation. The haptic module 379 may include, for example, a motor, a piezoelectric element, or an electrical stimulator.

The camera module 380 may capture a still image or moving images. The camera module 380 may include one or more lenses, image sensors, image signal processors, or flashes. The power management module 388 may manage power supplied to the electronic device 301. The power management module 388 may be implemented as at least part of, for example, a power management integrated circuit (PMIC).

The battery 389 may supply power to at least one component of the electronic device 301. The battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more communication processors that are operable independently from the processor 320 (e.g., the AP) and supports a direct (e.g., wired) communication or a wireless communication. The communication module 390 may include a wireless communication module 392 (e.g., a cellular communication module, a short-range wireless communication module, or a global navigation satellite system (GNSS) communication module) or a wired communication module 394 (e.g., a local area network (LAN) communication module or a power line communication (PLC) module). A corresponding one of these communication modules may communicate with the external electronic device via the first network 398 (e.g., a short-range communication network, such as BLUETOOTH™, wireless-fidelity (Wi-Fi) direct, or a standard of the Infrared Data Association (IrDA)) or the second network 399 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 392 may identify and authenticate the electronic device 301 in a communication network, such as the first network 398 or the second network 399, using subscriber information (e.g., international mobile subscriber identity (IMSI)) stored in the subscriber identification module 396.

The antenna module 397 may transmit or receive a signal or power to or from the outside (e.g., the external electronic device) of the electronic device 301. The antenna module 397 may include one or more antennas, and, therefrom, at least one antenna appropriate for a communication scheme used in the communication network, such as the first network 398 or the second network 399, may be selected, for example, by the communication module 390 (e.g., the wireless communication module 392). The signal or the power may then be transmitted or received between the communication module 390 and the external electronic device via the selected at least one antenna.

Commands or data may be transmitted or received between the electronic device 301 and the external electronic device 304 via the server 308 coupled with the second network 399. Each of the electronic devices 302 and 304 may be a device of a same type as, or a different type, from the electronic device 301. All or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 301. The electronic device 301 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for data augmentation, the method comprising:
obtaining a plurality of noisy spectrograms;
extracting noise components from the plurality of noisy spectrograms;
individually generating a mixup coefficient for each of the extracted noise components;
applying the mixup coefficients to the extracted noise components;
merging the extracted noise components; and
combining the merged noise components with a clean spectrogram to provide an augmented sample.

2. The method of claim 1, further comprising training a model using the augmented sample and a loss function.

3. The method of claim 2, wherein the loss function is generated based on at least one of a magnitude loss, a complex loss, a time loss, a perceptual evaluation of speech quality (PESQ) loss, or a scale invariant signal to distortion ratio (SI-SDR) loss.

4. The method of claim 3, wherein the magnitude loss is determined based on a magnitude of an enhanced waveform, a magnitude of a clean target waveform, a magnitude of a clean target spectrogram, and a magnitude of an enhanced target spectrogram.

5. The method of claim 3, wherein the complex loss is determined based on a real value of an enhanced waveform, a real value of a clean target waveform, a real value of a clean target spectrogram, and a real value of an enhanced target spectrogram.

6. The method of claim 3, wherein the time loss is determined based on a difference between an enhanced waveform and a clean target waveform.

7. The method of claim 3, wherein each of the PESQ loss and the SI-SDR loss is determined based on an enhanced waveform and a clean target waveform.

8. The method of claim 1, wherein each of the plurality of noisy spectrograms is a compressed spectrogram that is determined based on a complex spectrogram corresponding to a magnitude, a phase, a real component, and an imaginary component of the compressed spectrogram.

9. A system for performing data augmentation, the system comprising:
a processor; and
a memory configured to store instructions, which when executed, control the processor to:
obtain a plurality of noisy spectrograms,
extract noise components from the plurality of noisy spectrograms,
individually generate a mixup coefficient for each of the extracted noise components,
apply the mixup coefficients to the extracted noise components,
merge the extracted noise components, and
combine the merged noise components with a clean spectrogram to provide an augmented sample.

10. The system of claim 9, wherein the instructions, when executed, further control the processor to train a model using the augmented sample and a loss function.

11. The system of claim 10, wherein the loss function is generated based on at least one of a magnitude loss, a complex loss, a time loss, a perceptual evaluation of speech quality (PESQ) loss, or a scale invariant signal to distortion ratio (SI-SDR) loss.

12. The system of claim 11, wherein the magnitude loss is determined based on a magnitude of an enhanced waveform, a magnitude of a clean target waveform, a magnitude of a clean target spectrogram, and a magnitude of an enhanced target spectrogram.

13. The system of claim 11, wherein the complex loss is determined based on a real value of an enhanced waveform, a real value of a clean target waveform, a real value of a clean target spectrogram, and a real value of an enhanced target spectrogram.

14. The system of claim 11, wherein the time loss is determined based on a difference between an enhanced waveform and a clean target waveform.

15. The system of claim 11, wherein each of the PESQ loss and the SI-SDR loss is determined based on an enhanced waveform and a clean target waveform.

16. An electronic device for performing data augmentation, the electronic device comprising:
a microphone; and
a processor configured to:
receive an audio signal via the microphone,
obtain a plurality of noisy spectrograms from the audio signal,
extract noise components from the plurality of noisy spectrograms,
individually generate a mixup coefficient for each of the extracted noise components,
apply the mixup coefficients to the extracted noise components,
merge the extracted noise components, and
combine the merged noise components with a clean spectrogram to provide an augmented sample.

17. The electronic device of claim 16, wherein the processor is further configured to train a model using the augmented sample and a loss function.

18. The electronic device of claim 17, wherein the loss function is generated based on at least one of a magnitude loss, a complex loss, a time loss, a perceptual evaluation of speech quality (PESQ) loss, or a scale invariant signal to distortion ratio (SI-SDR) loss.

19. The electronic device of claim 18, wherein the magnitude loss is determined based on a magnitude of an enhanced waveform, a magnitude of a clean target waveform, a magnitude of a clean target spectrogram, and a magnitude of an enhanced target spectrogram.

20. The electronic device of claim 18, wherein the complex loss is determined based on a real value of an enhanced waveform, a real value of a clean target waveform, a real value of a clean target spectrogram, and a real value of an enhanced target spectrogram.
